(19) United States
(12) Patent Application Publication
(10) Pub. No.: US 2007/0195252 A1
(43) Pub. Date: Aug. 23, 2007

(54) Electronic Ink Display

(76) Inventors: Yu-chi Tsai, Hsinchu (TW); Yu-Chen Hsu, Hsinchu (TW); Chi-Ming Wu, Hsinchu (TW)

Correspondence Address: GLENN PATENT GROUP, 3475 EDISON WAY, SUITE L, MENLO PARK, CA, 94025, US

(21) Appl. No.: 11/552,912

(22) Filed: Oct. 25, 2006

(30) Foreign Application Priority Data
Feb. 22, 2006 (TW) 95105877

(51) Int. Cl. G02F 1/1343

(52) U.S. Cl. 349/143

(57) ABSTRACT

An electronic ink display including a first substrate, at least one metallic pattern layer, plural pixel electrodes, a sealant and a front plane laminate is provided. The pixel electrodes are located on a display area of the first substrate. The metallic pattern layer having a plurality of holes is located on a peripheral circuit area surrounding the display area. The sealant is disposed on the edge of the first substrate and a part of the sealant is overlaid on the metallic pattern layer. The front plane laminate is disposed on one side of the first substrate. The front plane laminate includes a second substrate, a common electrode disposed on the second substrate and an electronic ink material layer disposed between the common electrode and the first substrate.

### RELATED APPLICATIONS

The present application is based on, and claims priority from, Taiwan Application Serial Number 95105877, filed Feb. 22, 2006, the disclosure of which is hereby incorporated by reference herein in its entirety.

### BACKGROUND

1. Field of Invention

The present invention relates to a display. More particularly, the present invention relates to an electronic ink display.

2. Description of Related Art

Regarding the developing of display technology, novel displays have been used in portable computer, mobile phone, digital camera and other electronic products. Among those displays, electronic ink display, liquid crystal display (LCD) and organic light-emitting display (OLED) are the most potential displays.

The development of electronic ink displays began in the 1970s. The electronic ink display comprises many charged balls. One side of each ball is white and the other side is black. When the electric field in the electronic ink display is altered, the balls rotate and then different colors can be displayed. The second generation of electronic ink displays started in the 1990s. In this generation, microcapsules replace traditional balls. The microcapsules are filled with colorful oil and a plurality of white charged particles. By altering the external electric field, the particles move toward different directions. When the particles move upward, the microcapsules display white color. When the particles move downward, the microcapsules display the color of the oil.

The electronic ink display generally comprises a front plane laminate and a thin film transistor (TFT) array substrate. The front plane laminate and the TFT array substrate are sealed by ultraviolet (UV) curable sealant. The front plane laminate comprises a transparent electrode and an electronic ink material layer. The electronic ink material layer contains plural electronic inks. The electronic inks are reflective display material comprising a bi-stable characteristic and using the charged particles to provide display. Each of the charged particles may contain single polarity or both positive and negative polarity. When the electric field between the transparent electrode and the pixel electrode of the TFT array substrate is altered, the charged particles in the electronic inks start moving and further provide a display.

Referring to FIG. 1, a vertical view of the TFT array substrate of an ordinary electronic ink display is shown. The TFT array substrate 100 comprises a substrate 110, a plurality of pixel electrodes 120, a plurality of TFTs 130 and common electrode pattern layers 140. The substrate 110 includes a display area 112 and a peripheral circuit area 114 surrounding the display area 112. The pixel electrodes 120 and the TFTs 130 are disposed on the display area 112. Each of the TFTs 130 is electrically connected to corresponding pixel electrode 120 to adjust the voltage of each pixel electrode 120. The common electrode pattern layers 140 are located on the peripheral circuit region 114.

During an assembling process of the TFT array substrate 100 and the front plane laminate (not shown in the drawing), the UV curable sealant 50 is coated on the TFT array substrate 100. UV light is used to cure the UV curable sealant 50. In the assembling process described above, due to some part of the UV curable sealant 50 located on the common electrode pattern layer 140, UV light is shielded by the common electrode pattern layer 140. Therefore, the UV curable sealant 50 located on the common electrode pattern layer 140 can not be completely cured by insufficient UV light. The incomplete curing reaction reduces sealed effectiveness between the front plane laminate and the TFT array substrate 100. Therefore, water resistibility and assembling quality of the electronic ink display are both decreased.

### SUMMARY

An electronic ink display including a first substrate, at least one metallic pattern layer, plural pixel electrodes, a sealant and a front plane laminate is provided. The pixel electrodes are located on a display area of the first substrate. The metallic pattern layer having a plurality of holes is located on a peripheral circuit area surrounding the display area. The sealant is disposed on the edge of the first substrate and a part of the sealant is overlaid on the metallic pattern layer. The front plane laminate is disposed on one side of the first substrate. The front plane laminate includes a second substrate, a common electrode disposed on a surface facing to the first substrate of the second substrate and an electronic ink material layer disposed between the common electrode and the first substrate.

A display device comprising a first substrate, at least one metallic pattern layer having plural holes, a sealant, a second substrate and plural pixel units is provided. The first substrate has a display area and a peripheral circuit area surrounding the display area. The metallic pattern layer having plural holes is located on the peripheral circuit area. The sealant is located on the edge of the first substrate and a part of the sealant is overlaid on the metallic pattern layer. The second substrate is located above the first substrate. The pixel units are located on the display area of the first substrate and between the first substrate and the second substrate.

### BRIEF DESCRIPTION OF THE DRAWINGS

These and other features, aspects, and advantages of the present invention will become better understood with regard to the following description, appended claims, and accompanying drawings where:

FIG. 1 shows a vertical view of the thin film transistor array substrate of an ordinary electronic ink display.

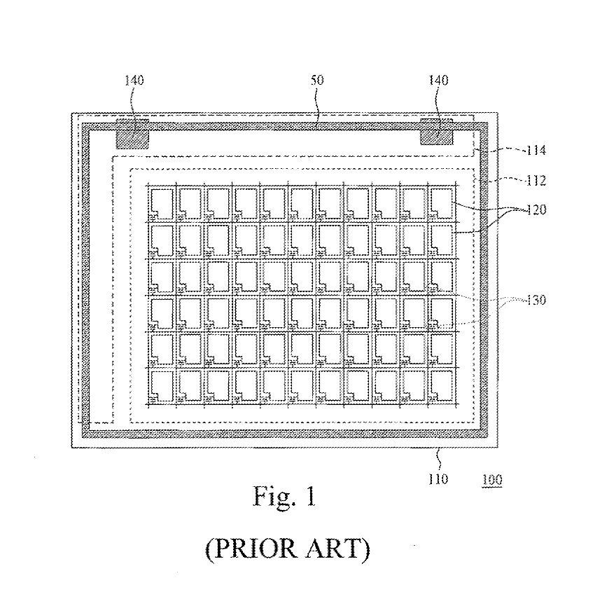

FIG. 2 shows a cross-sectional view of an electronic ink display according to one embodiment of the present invention.

FIG. 3A shows a vertical view of the thin film transistor array substrate in FIG. 2.

FIG. 3B shows a vertical view of the front plane laminate in FIG. 2.

FIG. 4 shows a cross-sectional view of an electronic ink display according to one embodiment of the present invention.

FIG. 5A shows a cross-sectional view of a display according to one embodiment of the present invention.

FIG. 5B shows a cross-sectional view of a display according to one embodiment of the present invention.

### DETAILED DESCRIPTION

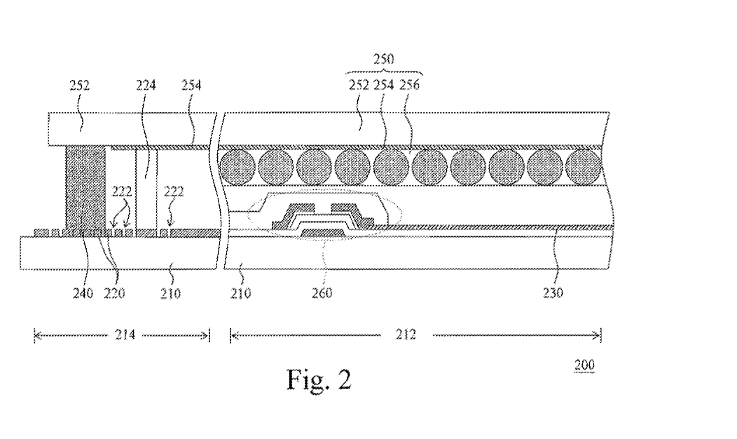

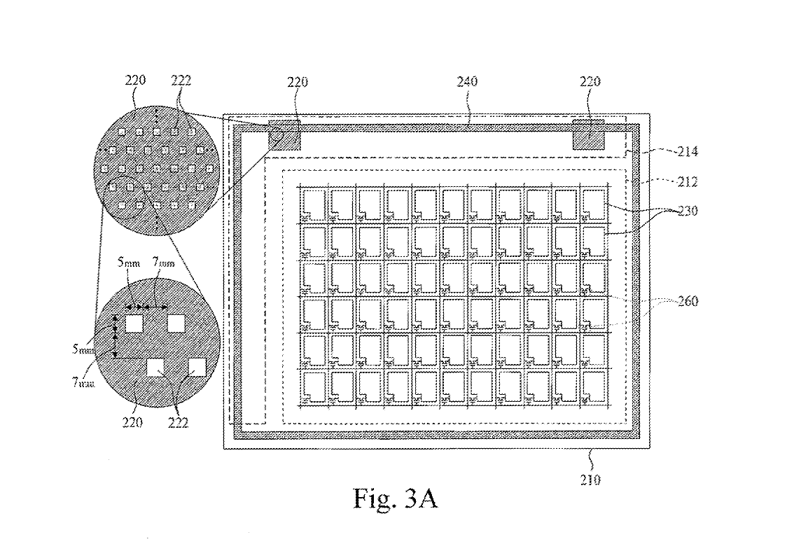

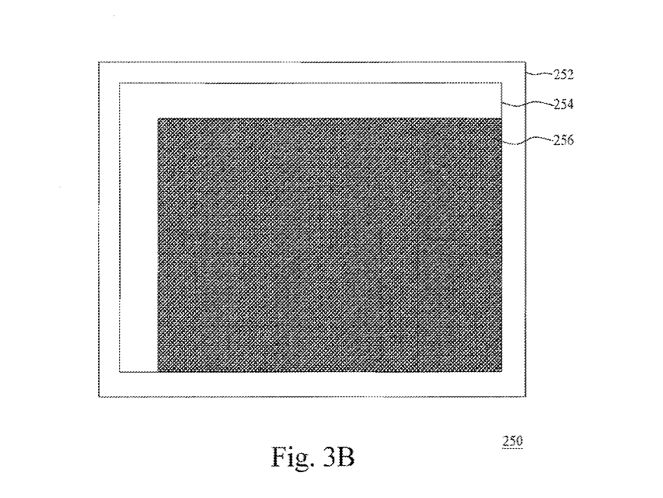

Referring to FIG. 2, a cross-sectional view of an electronic ink display according to one embodiment of the present invention is shown. FIG. 3A shows a vertical view of the thin film transistor (TFT) array substrate in FIG. 2. FIG. 3B shows a vertical view of the front plane laminate in FIG. 2. Referring to FIG. 2, FIG. 3A and FIG. 3B, the electronic ink display 200 includes a first substrate 210, at least one metallic pattern layer 220, a plurality of pixel electrodes 230, a sealant 240 and a front plane laminate 250. The first substrate 210 has a display area 212 and a peripheral circuit area 214 surrounding the display area 212. The pixel electrodes 230 are located on the display area 212. The metallic pattern layer 220 is located on the peripheral circuit area 214 and comprises a plurality of holes 222. The sealant 240 is located on the edge of the first substrate 210. A part of the sealant 240 is overlaid on the metallic pattern layer 220. The front plane laminate 250 is located on one side of the first substrate 210. The front plane laminate 250 comprises a second substrate 252, a common electrode 254 and an electronic ink material layer 256. The common electrode 254 is located on a surface of the second substrate 252, wherein the surface is adjacent to the first substrate 210. The electronic ink material layer 256 is located between the common electrode 254 and the first substrate 210.

In one embodiment, the sealant 240 may be an UV curable sealant. During an assembling process of the first substrate 210 and the front plane laminate 250, the sealant 240 is coated on the edge of the first substrate 210. Moreover, an UV light is provided to the sealant 240 to cure the sealant 240. Therefore, the sealant can be used to seal up the first substrate 210 and the front plane laminate 250 and prevent vapor diffusing into the electronic ink display. Compared to the ordinary electronic ink display, the metallic pattern layer 220 in the embodiment of the present invention comprises a plurality of holes 222. The holes 222 in the metallic pattern layer 220 provide an UV light transmission path. Therefore, the sealant 240 on the metallic pattern layer 220 receives sufficient ultraviolet energy to carry out curing reaction. The sealed effectiveness between the first substrate 210 and the front plane laminate 250 is increased. In one embodiment, the sealant 240 is a photo curable sealant.

Referring to FIG. 3A, in one embodiment of the present invention, the pattern of the holes 222 may be a honeycomb pattern. The honeycomb pattern holes provide good conductivity for the metallic pattern layer 220 and permit light to pass through the metallic pattern layer 220. In one embodiment, each hole 222 is a 5×5 mm² hole. The distance between two adjacent holes 222 is 7 mm. Certainly, the pattern, shape, size and distance of the hole 222 are not limited. For example, the pattern of the holes 222 may be a matrix pattern, the shape of each hole 222 may be a rectangle, circle, ellipse, other suitable shapes or a combination thereof.

Referring to FIG. 2, in one embodiment, the metallic pattern layer 220 is electrically connected to the common electrode 254 by silver glue. Therefore, the voltage applied to the metallic pattern layer 220 is also applied to the common electrode 254. When the electronic ink display 200 is used, the voltage applied on the pixel electrodes 230 is adjusted, and the voltage difference between the pixel electrodes 230 and the common electrode 254 further generates an electric field. The electronic ink particles in the electronic ink material layer 256 are driven by the electric field so an image can be displayed. However, the function of the metallic pattern layer 220 is not limited to the description given above.

Referring to the FIG. 2 and FIG. 3A, the electronic ink display 200 further comprises a plurality of thin film transistors (TFTs) 260 and acts as an active matrix electronic ink display. The TFTs 260 are located on the first substrate 210. Each of the TFTs 260 is electrically connected to the corresponding pixel electrode 230. The TFTs 260 drives the voltage of each pixel electrode 230 in the pixel. However, the electronic ink display in the embodiment of the present invention is not limited to the active matrix type, the present invention can be applied to both active and passive matrix type.

In one embodiment, the first substrate 210 and the second substrate 252 may be glass substrate or flexible substrate. The material of the first substrate 210 and the second substrate 252 is not limited to any specific material in this invention.

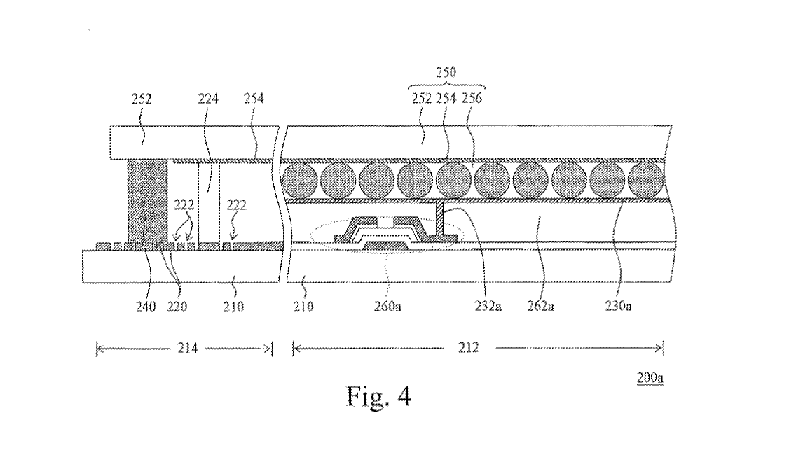

Referring to FIG. 4, a cross-sectional view of the electronic ink display according to one embodiment of the present invention is shown. The electronic ink display 200a is similar to the electronic ink display 200 in FIG. 2. However, the electronic ink display 200a comprises a dielectric layer 262a between the pixel electrodes 230a and the TFTs 260a. Each pixel electrode 230a is electrically connected to each TFT 260a through a plug 232a.

Accordingly, the metallic pattern layer 220 overlaid by the sealant 240 has plural holes 222, UV light passes through the holes 222 and transmits to the sealant 240. Therefore, the sealant 240 on the metallic pattern layer 220 receives enough ultraviolet energy to carry out a curing reaction. It increases the curing effectiveness of the sealant 240 and further improves the packaged quality for the electronic ink display 200 and 200a. The present invention can be applied to other display and will be further discussed in other embodiment.

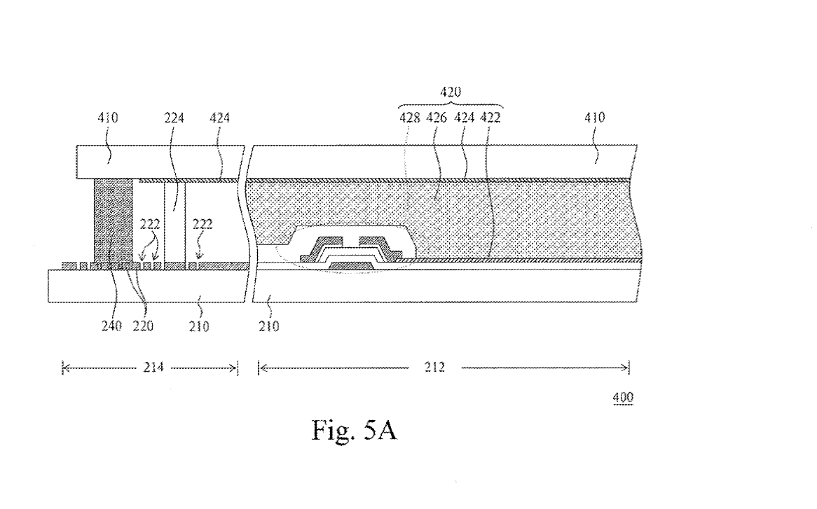

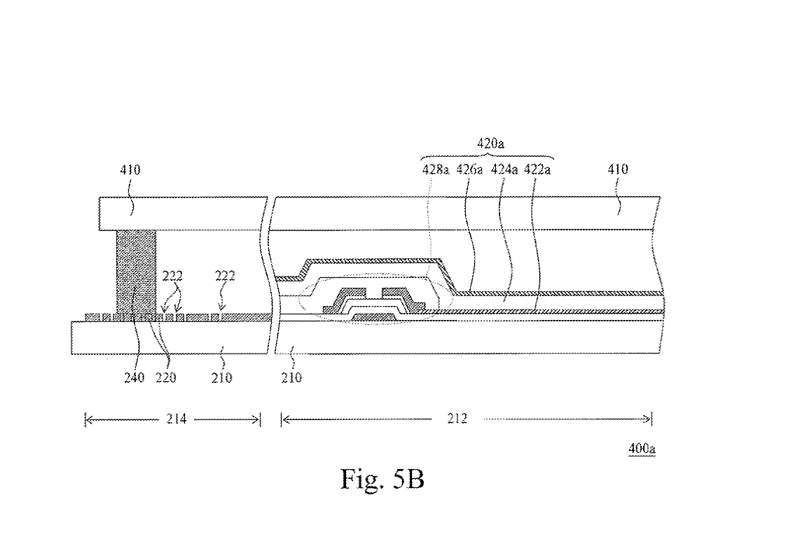

Referring to FIG. 5A, a cross-sectional view of the display according to one embodiment of the present invention is shown. The display 400 is similar to the electronic ink display 200 given above. The display 400 comprises the first substrate 210, the metallic pattern layer 220, the sealant 240, a second substrate 410 and a plurality of pixel units 420. The second substrate 410 is located above the first substrate 210. The pixel units 420 are disposed on the display area 212 of the first substrate 210 and between the first substrate 210 and the second substrate 410.

As given above, the characteristics of the metallic pattern layer 220 and the sealant 240 are described. Therefore, the present invention can increase the curing effectiveness of the sealant 240 between the first substrate 210 and the second substrate 410. It further increases the packaging quality and the water resistibility of the display 400.

In one embodiment, the display 400 in the FIG. 5A may be a liquid crystal display (LCD). Each pixel unit 420 includes a pixel electrode 422, a common electrode 424 and a liquid crystal layer 426. The pixel electrode 422 is located on the first substrate 210. The common electrode 424 is located on a surface of the second substrate 410, wherein the surface is adjacent to the first substrate 210. The liquid crystal layer 426 is located between the pixel electrode 422 and the common electrode 424. By altering the electric field between the pixel electrode 422 and the common electrode 424, the liquid crystal 426 can be used as a valve to control the intensity of the light passing through the liquid crystal 426. By using a color filter (not shown in the drawing) in the display 400, the color of each pixel can be adjusted. Besides, to be an active matrix LCD, each pixel unit 420 further comprises a TFT 428 located on the first substrate 210. The TFT 428 is electrically connected to the pixel electrode 422. However, the display 400 can also be a passive matrix display.

Referring to the FIG. 5B, a cross-sectional view of the display according to one embodiment of the present invention is shown. The display 400a is similar to the display 400. The difference between of two displays is discussed as following. The display 400a may be an organic light-emitting display (OLED). The pixel unit 420a includes an anode electrode 422a, an organic luminescent layer 424a and a cathode electrode 426a. The anode electrode 422a is located on the first substrate 210. The organic luminescent layer 424a is located on the anode cathode 422a. The cathode electrode 426a is located on the organic luminescent layer 424a. The hole from the anode electrode 422a and the electron from the cathode electrode 426a are combined in the organic luminescent layer 424a and then generate light. By altering the magnitude of the working current, the light intensity of each pixel can be adjusted. To be an active matrix OLED, each pixel unit 420a further comprises at least one TFT 428a located on the first substrate 210. The TFT is electrically connected to the corresponding anode electrode 422a. However, the display 400a can also be a passive matrix OLED.

Similarly, the display 400 and 400a, as well as the electronic ink display 200 and 200a, comprises the metallic pattern layer 220 having plural holes 222. UV light passes through the holes 222 and transmits to the sealant 240 on the metallic pattern layer 220. Therefore, the sealant 240 on the metallic pattern layer 220 receives sufficient ultraviolet energy to carry out curing reaction. It increases the curing effectiveness of the sealant 240 and further improves the packages quality of the electronic ink display 400 and 400a.

However, the present invention is not limited to the display described above. For example, it can also be applied to plasma display or other displays. If a display comprises a larger metallic pattern layer near the sealant, a metallic pattern layer with holes provided in the present invention can be used to increase the curing effectiveness of the sealant for the display. It further improves packaged quality and water resistibility of the display.

As described above, the electronic ink display and the display in the embodiment of the present invention comprise following advantages:

1. The method of using the metallic pattern layer with holes permits ultraviolet light to pass through the metallic pattern layer. Therefore, the sealant can receive sufficient ultraviolet energy and complete the curing reaction. The sealing effectiveness of the sealant between two substrates is increased and the sealant thereof can be used to avoid vapor diffusing into the display. This method provides a display with better-packages quality and water resistibility.

2. The honeycomb like holes arrangement on the metallic pattern layer reduces negative effect of holes on conductivity. Therefore, the metallic pattern layer still has good conductivity.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic ink display, comprising:
a first substrate having a display area and a peripheral circuit area surrounding the display area;
at least one metallic pattern layer having a plurality of holes, located on the peripheral circuit area;
a plurality of pixel electrodes located on the display area;
a sealant located on the edge of the first substrate, wherein a part of the sealant is overlaid on the metallic pattern layer;
a front plane laminate disposed on one side of the first substrate, wherein the front plane laminate comprises:
a second substrate;
a common electrode, disposed on a surface facing the first substrate of the second substrate; and
an electronic ink material layer, located between the common electrode and the first substrate.

2. The electronic ink display of claim 1, wherein the pattern of the holes is honeycomb pattern or matrix pattern.

3. The electronic ink display of claim 1, wherein the shape of the holes is selected from a group consisting of square, rectangle, circle, ellipse, and a combination thereof.

4. The electronic ink display of claim 1, wherein the holes are a plurality of square holes.

5. The electronic ink display of claim 4, wherein each of the holes is about 5×5 mm² and the distance between two adjacent holes is about 7 mm.

6. The electronic ink display of claim 1, wherein the sealant is an ultraviolet curable sealant.

7. The electronic ink display of claim 1, wherein the metallic pattern layer is electrically connected to the common electrode.

8. The electronic ink display of claim 1, further comprising a plurality of thin film transistors located on the first substrate, each of the thin film transistors being electrically connected to each of the pixel electrodes.

9. The electronic ink display of claim 1, wherein the first substrate is a flexible substrate or a glass substrate.

10. The electronic ink display of claim 1, wherein the second substrate is a flexible substrate or a glass substrate.

11. A display device, comprising:
a first substrate having a display area and a peripheral circuit area surrounding the display area;
at least one metallic pattern layer having a plurality of holes, located on the peripheral circuit area;
a sealant located on the edge of the first substrate, wherein a part of the sealant is overlaid on the metallic pattern layer;
a second substrate located above the first substrate; and
a plurality of pixel units disposed on the display area of the first substrate and located between the first substrate and the second substrate.

12. The display device of the claim 11, wherein the pattern of the holes is honeycomb pattern or matrix pattern.

13. The display device of claim 11, wherein the shape of the holes is selected from a group consisting of square, rectangle, circle, ellipse, and a combination thereof.

14. The display device of claim 11, wherein the holes are a plurality of square holees.

15. The sidplay device of claim 14, wherein each of the holes is about 5×5 mm² and the distance of two adjacent holes is about 7 mm.

16. The display device of claim 11, wherein the sealant is an ultraviolet curable sealant.

17. The display device of claim 11, wherein each of the pixel units comprises:
a pixel electrode located on the first substrate;
a common electrode located on a surface of the second electrode, wherein the surface is adjacent to the first substrate; and
a liquid crystal layer located between the pixel electrode and the common electrode.

18. The display device of claim 17, further comprising a thin film transistor located on the first substrate and electrically connected to the pixel electrode.

19. The display device of claim 17, wherein the metallic pattern layer is electrically connected to the common electrode.

20. The display device of claim 11, wherein each of the pixel units comprises:
an anode electrode located on the first substrate;
an organic luminescent layer located on the anode; and
a cathode electrode located on the organic luminescent layer.

21. The display device of claim 20, further comprising at least one thin film transistor located on the first substrate and electrically connected to the anode electrode.

22. The display device of claim 11, wherein the first substrate is a flexible substrate or a glass substrate.

23. The display device of claim 11, wherein the second substrate is a flexible substrate or a glass substrate.
